(19) United States
(12) Patent Application Publication
(10) Pub. No.: US 2024/0396352 A1
(43) Pub. Date: Nov. 28, 2024

(54) METHOD OF CHARGING A VALVE ASSEMBLY ENERGY STORAGE, AND VALVE ASSEMBLY

(71) Applicant: Buerkert Werke GmbH & Co. KG, Ingelfingen (DE)

(72) Inventors: Sesha Balaji VENKATARAMANI, Ingelfingen (DE); Simon KASTNER, Ingelfingen (DE)

(21) Appl. No.: 18/672,633

(22) Filed: May 23, 2024

(30) Foreign Application Priority Data
May 26, 2023 (DE) 102023114013.2

(51) Int. Cl. H02J 7/00; F16K 31/04

(52) U.S. Cl. CPC H02J 7/00712; H02J 7/0048; H02J 7/005; H02J 7/007192; F16K 31/04

(57) ABSTRACT

A method of charging a valve assembly energy storage of an energy storage unit of a valve assembly having an electric motor-driven process valve is indicated, the valve assembly energy storage being configured to supply an electric motor of the process valve with electrical energy, wherein the valve assembly energy storage is charged with a first charging current up to a defined lower state-of-charge limit and is charged with a second charging current, which is less than the first charging current, up to an upper state-of-charge limit. Furthermore, a valve assembly is indicated.

### TECHNICAL FIELD

The present disclosure relates to a method of charging a valve assembly energy storage of an energy storage unit of a valve assembly having an electric motor-driven process valve and to a valve assembly having an electric motor-driven process valve and having an energy storage unit which includes a valve assembly energy storage.

### BACKGROUND

Valve assemblies having a valve assembly energy storage are known. A valve assembly energy storage may ensure an emergency power supply in order to move the process valve to a safety position, for example to a closed position, in the event of a power outage.

In electric motor-driven process valves, which have an electric motor drive, the necessary electrical energy for the electric motor of the process valve is made available by the valve assembly energy storage in the event of a power outage, for the process valve to be able to move to a desired position.

To be able to provide the necessary electrical energy, the valve assembly energy storage needs to be charged at least up to a lower state-of-charge limit.

Such valve assembly energy storages have the drawback that the charging process takes a relatively long time, e.g. during an initial start-up operation.

It is therefore an object of the present disclosure to allow a valve assembly energy storage to be charged as fast as possible.

### SUMMARY

The present disclosure provides a method of charging a valve assembly energy storage of an energy storage unit of a valve assembly having an electric motor-driven process valve, the valve assembly energy storage being configured to supply an electric motor of the process valve with electrical energy, wherein the valve assembly energy storage is charged with a first charging current up to a defined lower state-of-charge limit and is charged with a second charging current, which is less than the first charging current, up to an upper state-of-charge limit.

The method according to the disclosure has the advantage that the charging process up to the lower state-of-charge limit is e.g. fast owing to the higher first charging current, so that the valve assembly energy storage is ready for use quickly.

After the valve assembly energy storage has been charged to the lower state-of-charge limit, charging takes place more slowly than before due to the second charging current being lower, resulting in gentle treatment of the valve assembly energy storage.

The method according to the disclosure relates e.g. to an initial charging prior to the start-up operation of the valve assembly energy storage or a charging after a power outage.

For the lower state-of-charge limit, the valve assembly energy storage may provide a minimum voltage which can be used to implement an emergency function, e.g. shutting off the process valve.

The upper state-of-charge limit corresponds, for example, to a nominal voltage of the valve assembly energy storage. This means that the valve assembly energy storage could be charged beyond the upper state-of-charge limit. But since the upper state-of-charge limit is below the maximum possible state of charge, the valve assembly energy storage is treated gently, which is also advantageous with a view to service life.

At least one of the lower state-of-charge limit and the upper state-of-charge limit is, for example, dependent on an operating parameter of the process valve, e.g. on at least one of a fluid pressure and a wear and an ambient temperature. This is also advantageous with a view to the aging of the valve assembly energy storage, since the lower state-of-charge limit is designed according to requirements and is not higher than necessary.

Depending on the fluid pressure, in fact, a load acting on the electric motor of the process valve varies, so that a required minimum voltage or lower state-of-charge limit also varies as a function of the fluid pressure. As the fluid pressure increases, a higher minimum voltage is required to ensure the emergency function, so that the lower state-of-charge limit has to be raised.

Generally, the lower state-of-charge limit is defined during the start-up operation.

It is also conceivable, however, that the lower state-of-charge limit is variable if, for example, the fluid pressure in the process valve varies during operation.

The upper state-of-charge limit may be increased as the capacity of the valve assembly energy storage decreases. This means that the upper state-of-charge limit is variable during operation of the process valve. This allows aging processes to be offset and the required charging time can be kept approximately constant during the service life of the valve assembly energy storage.

In one embodiment, the lower state-of-charge limit is variable, with the upper state-of-charge limit increasing when the lower state-of-charge limit is increased.

The upper state-of-charge limit is e.g. below a maximum charging capacity of the valve assembly energy storage. This also provides for an extended service life of the valve assembly energy storage.

A diagnosis can be performed at cyclic time intervals to determine a state of health, e.g. the capacity, of the valve assembly energy storage, wherein the valve assembly energy storage is discharged in a targeted manner and the voltage and amperage are measured in the process, and the state of health of the valve assembly energy storage is determined based on the drop in voltage and amperage over time. In this way, it is possible to react to an aging process of the valve assembly energy storage, e.g. by increasing the upper state-of-charge limit. If the valve assembly energy storage can no longer meet the necessary requirements due to its state of health, a request for replacement or an alert that the valve assembly energy storage should be replaced in the near future may be provided.

The valve assembly energy storage may be charged beyond the upper state-of-charge limit immediately before performing the diagnosis. This allows the state of charge of the valve assembly energy storage to correspond to the upper state-of-charge limit after the diagnosis, that is, the energy storage is ready for use after the diagnosis and need not be charged again immediately.

However, the valve assembly energy storage is not charged up to the maximum charging capacity of the valve assembly energy storage to carry out the diagnosis.

A diagnosis takes place at time intervals of 100 hours to 200 hours, for example.

According to one embodiment, the data acquired during the diagnosis is stored. A charging current, a discharging current, an internal resistance, a time period for charging/discharging the energy storage and/or a capacity can be stored. This allows a future aging of the energy storage to be estimated after at least two diagnoses have been carried out.

The object is further achieved according to the disclosure by a valve assembly having an electric motor-driven process valve and having an energy storage unit which includes a valve assembly energy storage and an energy storage control unit, the valve assembly energy storage being configured to supply energy to the electric motor of the process valve, and wherein the energy storage control unit is configured to control a charging current for charging the valve assembly energy storage in accordance with the method according to the disclosure.

As already described in connection with the method according to the disclosure, a valve assembly of this type has the advantage that the valve assembly energy storage is ready for operation quickly in an initial start-up and, in addition, the service life of the valve assembly energy storage is increased.

The valve assembly energy storage is a supercapacitor, for example. Supercapacitors have the advantage over accumulators that they can be charged and discharged more quickly and endure more switching cycles.

The process valve comprises, for example, a valve control unit, the energy storage control unit being connected to the valve control unit in terms of signaling. This allows the energy storage control unit to send control signals to the valve control unit and, for example, indirectly control the electric motor of the process valve.

The energy storage control unit is configured, for example, to determine an energy available for charging. Based on the available energy, the energy storage control unit can fix the first charging current and the second charging current.

The energy storage unit may comprise a housing in which the energy storage control unit and the valve assembly energy storage are accommodated. In this way, the energy storage unit is compact in design and easy to handle.

The energy storage unit may either be attached directly to the process valve or housed at a distance from the process valve in a switch cabinet.

### BRIEF DESCRIPTION OF THE DRAWINGS

FIG. 1 shows a valve assembly according to the disclosure;

FIG. 2 schematically shows the internal structure of a valve assembly according to the disclosure;

FIG. 3 shows a graph for illustrating a charging process of a valve assembly energy storage;

FIG. 4 shows a further graph for illustrating a charging process of a valve assembly energy storage; and

FIG. 5 shows a graph for illustrating a capacity of a valve assembly energy storage as a function of an operating time.

### DETAILED DESCRIPTION

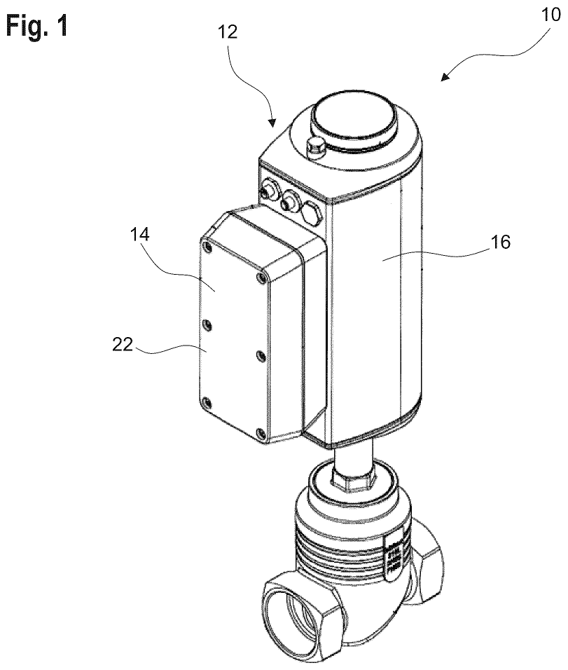

FIG. 1 shows a valve assembly 10 having a process valve 12 and an energy storage unit 14. The process valve 12 is an electric motor-driven process valve.

In the exemplary embodiment, the energy storage unit 14 is fastened directly to a housing 16 of the process valve 12.

It is, however, also conceivable that the energy storage unit 14 is arranged at a distance from the process valve 12 and is connected to the process valve 12 by means of a current-carrying line and a signal line.

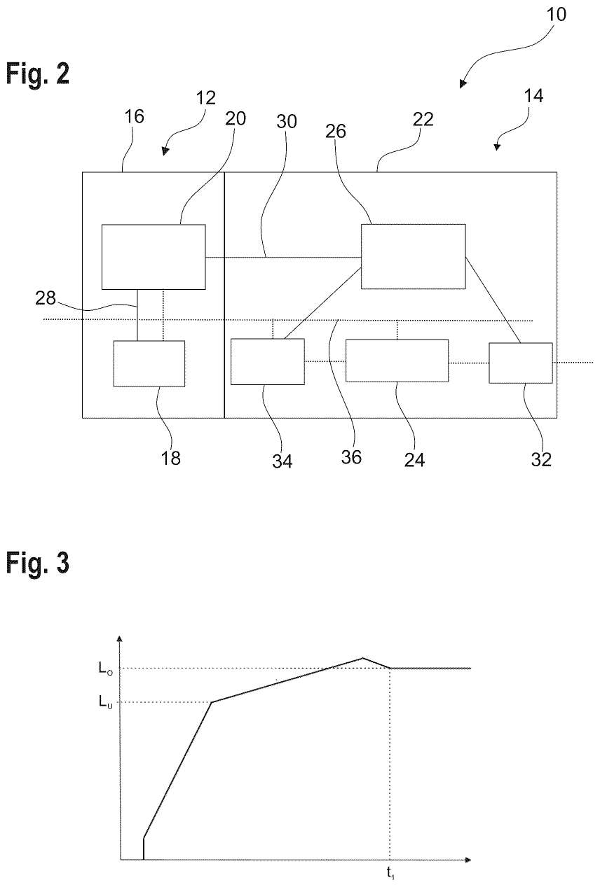

FIG. 2 schematically shows an internal structure of a valve assembly 10; it is not so much the spatial arrangement that is illustrated here, but rather the functional connection of the components.

The process valve 12 comprises an electric motor 18, not visible in FIG. 1, which is accommodated in the housing 16 and constitutes a drive of the process valve 12.

Furthermore, the process valve 12 includes a valve control unit 20 (see FIG. 2) for controlling the electric motor 18.

The energy storage unit 14 comprises a housing 22 in which a valve assembly energy storage 24, also not visible in FIG. 1, and an energy storage control unit 26 are accommodated.

The valve assembly energy storage 24 is, for example, a supercapacitor.

The valve control unit 20 is connected to the electric motor 18 by means of a signal line 28 in order to control the electric motor 18 in regular operation.

The energy storage control unit 26 is connected to the valve control unit 20 by means of a signal line 30 in terms of signaling. In this way, the energy storage control unit 26 can send signals to the valve control unit 20 to drive the electric motor 18.

The energy storage control unit 26 is furthermore configured to control a charging process for charging the valve assembly energy storage 24, e.g. by means of a parameterizable charging current and/or a parameterizable charging voltage.

For this purpose, the energy storage control unit 26 is connected to a charge controller 32 and a discharge controller 34 in terms of signaling.

Furthermore, the energy storage control unit 26 is configured to determine a voltage available for charging.

The valve assembly energy storage 24 is connected to the electric motor 18 by means of a current-carrying line 36 in order to supply the electric motor 18 with energy when required.

Moreover, the valve assembly energy storage 24 is also connected to the discharge controller 34 and the valve control unit 20 by means of current-carrying lines. In this way, all of the components required for controlling the process valve 12 can be supplied with electrical energy by the valve assembly energy storage 24 if necessary.

The energy storage unit 14 thus ensures an emergency power supply.

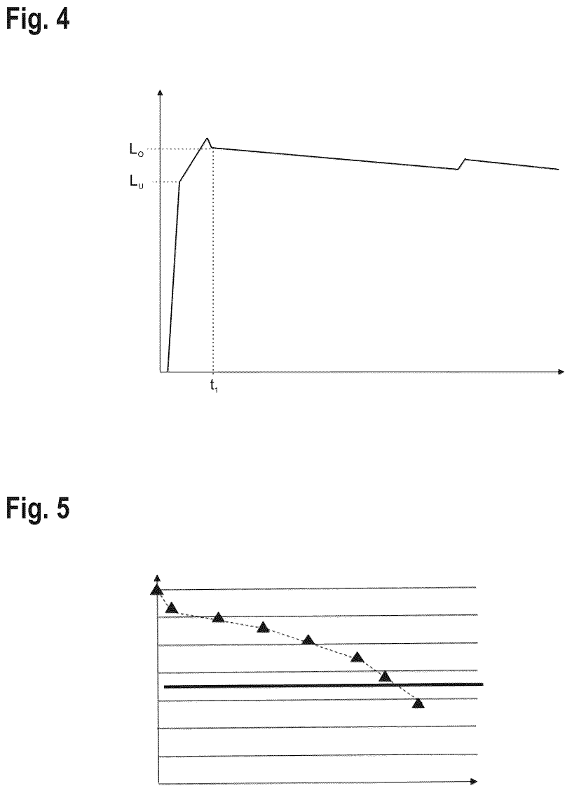

A method of charging the valve assembly energy storage 24 will be described below with reference to FIGS. 3 and 4.

In order to ensure the minimum functions of the process valve 12 in the event of a power outage, the valve assembly energy storage 24 has to be charged at least up to a defined lower state-of-charge limit L_{U}.

The lower state-of-charge limit L_{U} is dependent on an operating parameter of the process valve 12, e.g. a fluid pressure.

Furthermore, the lower state-of-charge limit L_{U} may depend on a valve type.

When the valve assembly energy storage 24 is charged, however, it is charged up to an upper state-of-charge limit L_{O} in order to ensure that the valve assembly energy storage 24 is ready for use for as long as possible between two charging processes.

The upper state-of-charge limit L_{O} is below a maximum charging capacity Lₘₐₓ of the valve assembly energy storage 24, that is, the valve assembly energy storage 24 could still be charged beyond the upper state-of-charge limit L_{O}. This, however, is only done occasionally for diagnostic purposes, as will be discussed below.

In FIG. 3, a charging process is plotted using a voltage over time, where the voltage represents the voltage that can be provided by the valve assembly energy storage 24.

When the energy storage unit 14 is initially placed into operation, the valve assembly energy storage 24 is first charged with a first charging current up to the lower state-of-charge limit L_{U}.

The first charging current is 5 amperes, for example.

As soon as the lower state-of-charge limit L_{U} is reached, the valve assembly energy storage 24 is further charged with a second charging current, which is less than the first charging current, up to the upper state-of-charge limit L_{O}.

The second charging current is, for example, less than half of the first charging current.

For example, the second charging current is 1 ampere.

As is apparent from the graph in FIG. 3, the valve assembly energy storage 24 is charged more slowly with the second charging current than with the first charging current.

FIG. 3 illustrates that the valve assembly energy storage 24 is initially charged beyond the upper state-of-charge limit L_{O}.

This is performed immediately before carrying out the diagnosis to determine a state of health of the valve assembly energy storage 24.

As part of the diagnosis, the valve assembly energy storage 24 is purposefully discharged and the voltage and amperage are measured in the process. Based on the drop in voltage and amperage over time, the state of health of the valve assembly energy storage 24 is determined.

A diagnosis of this type takes place at cyclic intervals.

The data collected during the diagnosis is stored.

Immediately after the diagnosis, the valve assembly energy storage 24 is still charged up to the upper state-of-charge limit L_{O}.

FIG. 4 shows a further graph for illustrating the charging process of the valve assembly energy storage 24, in which the voltage is also plotted over time. Up to the point in time t₁, at which the valve assembly energy storage is fully charged for the first time and a diagnosis has been completed, the voltage profile corresponds to the profile shown in FIG. 3.

As of the point in time t₁, a slow voltage drop can be observed, which is due to the fact that the valve assembly energy storage 24 drains in the course of time, even if no load is applied to the valve assembly energy storage 24.

As soon as the voltage has dropped to the lower state-of-charge limit L_{U}, the valve assembly energy storage 24 is charged again to the upper state-of-charge limit L_{O}, e.g. with the second charging current.

A diagnosis to determine the state of health of the valve assembly energy storage 24 takes place at regular time intervals.

FIG. 5 illustrates how a capacity of the valve assembly energy storage 24 decreases over time due to aging processes.

The points marked with triangles each indicate a time of a diagnosis.

In order to maintain the power of the valve assembly energy storage 24, the second charging voltage is increased as the capacity of the valve assembly energy storage 24 decreases.

The power of the valve assembly energy storage 24 is calculated in accordance with the formula P=0.5 C*U², where P denotes the power, C the capacity and U the voltage. It is apparent from the formula that a decrease in capacity can be compensated for by an increase in voltage.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of charging a valve assembly energy storage of an energy storage unit of a valve assembly having an electric motor-driven process valve, the valve assembly energy storage being configured to supply an electric motor of the process valve with electrical energy, wherein the valve assembly energy storage is charged with a first charging current up to a defined lower state-of-charge limit and is charged with a second charging current, which is less than the first charging current, up to an upper state-of-charge limit.

2. The method according to claim 1, wherein at least one of the lower state-of-charge limit and the upper state-of-charge limit is dependent on an operating parameter of the process valve.

3. The method according to claim 2, wherein at least one of the lower state-of-charge limit and the upper state-of-charge limit is dependent on at least one of a fluid pressure and a wear and an ambient temperature.

4. The method according to claim 1, wherein the upper state-of-charge limit is increased as the capacity of the valve assembly energy storage decreases.

5. The method according to claim 1, wherein the upper state-of-charge limit is below a maximum charging capacity of the valve assembly energy storage.

6. The method according to claim 1, wherein a diagnosis is performed at cyclic time intervals to determine a state of health of the valve assembly energy storage, wherein the valve assembly energy storage is discharged in a targeted manner while the voltage and amperage are measured, and the state of health of the valve assembly energy storage is determined based on the drop in voltage and amperage over time.

7. The method according to claim 6, wherein the valve assembly energy storage is charged beyond the upper state-of-charge limit immediately before performing the diagnosis.

8. The method according to claim 6, wherein the data acquired during the diagnosis is stored.

9. A valve assembly having an electric motor-driven process valve and having an energy storage unit which comprises a valve assembly energy storage and an energy storage control unit, the valve assembly energy storage being configured to supply energy to the electric motor of the process valve, and wherein the energy storage control unit is configured to control a charging current for charging the valve assembly energy storage in accordance with the method according to claim 1.

10. The valve assembly according to claim 9, wherein the valve assembly energy storage is a supercapacitor.

11. The valve assembly according to claim 9, wherein the process valve comprises a valve control unit, the energy storage control unit being connected to the valve control unit in terms of signaling.

12. The valve assembly according to claim 9, wherein the energy storage control unit is configured to determine an energy available for charging.

13. The valve assembly according to claim 9, wherein the energy storage unit comprises a housing in which the energy storage control unit and the valve assembly energy storage are accommodated.
